(19) United States
(12) Patent Application Publication
(10) Pub. No.: US 2018/0360020 A1
(43) Pub. Date: Dec. 20, 2018

(54) Insect Control Device

(71) Applicant: Warren Burch, Redmond, WA (US)

(72) Inventor: Warren Burch, Redmond, WA (US)

(21) Appl. No.: 15/623,831

(22) Filed: Jun. 15, 2017

(51) Int. Cl. A01M 1/22; A01N 61/00; A01M 1/04; A01M 1/02

(52) U.S. Cl. CPC A01M 1/223; A01M 1/023; A01M 1/04; A01N 61/00

(57) ABSTRACT

An insect control device may have a casing which includes a fine and tightly-spaced shock grid with sufficient energy to electrocute small insects. A detachable container for holding bait may be located below the grid. The insect control device may be highly effective at controlling infestations of small insects, for example, fruit flies.

### FIELD

This disclosure relates to an insect control device.

### BACKGROUND

Fruit flies can be a persistent nuisance. Many people resort to homegrown solutions to eliminate them. These may include vinegar to drown flies or strips of tape to trap flies at rest, for example. Homegrown solutions are often ineffective and burdensome.

Conventional insect control devices are not effective at eliminating smaller flying insects, for example, fruit flies and midges. Conventional devices often target larger insects, for example, flies and mosquitoes, and may require a user to swat the targets. Because of their small size and maneuverability, fruit flies are an unsatisfactory target for conventional devices. Fruit flies can pass through larger meshes unharmed and, because of their large populations, require much effort from the user.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, an insect control device. In one embodiment, the insect control device may comprise a casing having a tightly-spaced shock grid with sufficient energy to electrocute small insects. A detachable container for holding bait may be disposed below the grid. The insect control device may help control infestations of fruit flies, for example.

A person skilled in the art will understand that the insect control device and its components may comprise various shapes, colors, and sizes. The insect control device may be made of a material such as plastics, polymers, composites, rubber, wood, or metal, for example.

### BRIEF DESCRIPTION OF THE DRAWINGS

The present description may be better understood from the following detailed description read in light of the appended drawings, wherein:

FIG. 1 is a perspective view of an insect control device, according to one embodiment.

FIG. 2 is an exploded view of an insect control device, according to one embodiment.

FIG. 3 is a top view of an insect control device, according to one embodiment.

FIG. 4 is a side view of an insect control device, according to one embodiment.

FIG. 5 is a front view of an insect control device, according to one embodiment.

FIG. 6 is a rear view of an insect control device, according to one embodiment.

### DETAILED DESCRIPTION

A more particular description of certain embodiments of an insect control device may be had by references to the embodiments shown in the drawings that form a part of this specification, in which like numerals represent like objects.

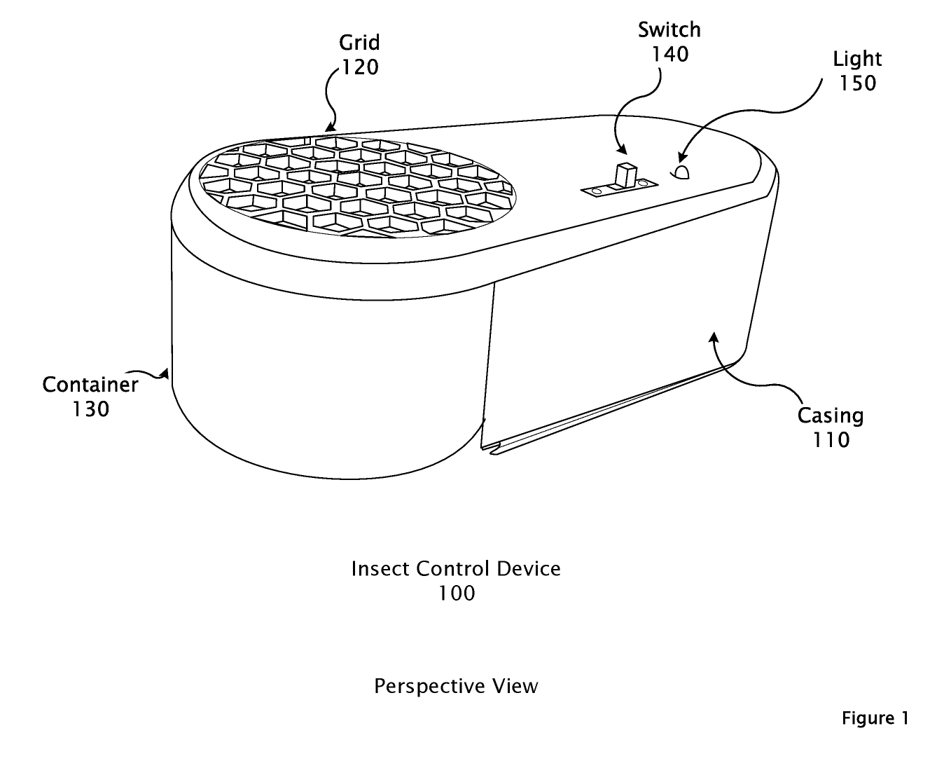

FIG. 1 is a perspective view of Insect Control Device 100, according to one embodiment. Insect Control Device 100 may be a baited trap comprising Casing 110, which may enclose electronics. Casing 110 may include an energized shock Grid 120, which may comprise a fine and tightly-spaced mesh with sufficient energy to electrocute small insects and prevent breeding. A detachable Container 130 may be disposed beneath Grid 120. Container 130 may hold bait and catch carcasses of electrocuted insects. Grid 120 or Casing 110 may serve as a lid that may be placed over Container 130.

On and off Switch 140 may be disposed on Casing 110. In one embodiment, Switch 140 may control a timer or other device settings. Light 150 may be disposed on Casing 110 to indicate that the device is on, motion has been detected, or other settings. In another embodiment, Light 150 may be a display indicating how many times the grid discharged since last powered on, indicating how many insects have been killed. One having skill in the art will recognize that other information, battery life or time activated, for example, may also be displayed.

A person skilled in the art will understand that Insect Control Device 100 and its components may comprise various shapes, colors, and sizes. In one embodiment, it may have properties attractive to small flying insects, for example, an alluring color, sound, or scent, a light in or behind Grid 120 such as an ultraviolet (UV) light-emitting diode (LED), or shapes or textures that mimic food or nature, for example. Insect Control Device 100 may be made of a combination of material, for example, polymers, composites, rubber, wood, or metal. In another embodiment, Insect Control Device 100 or its components may be made of an electrical insulator material, acid-resistant material, waterproof material, or glow-in-the-dark material.

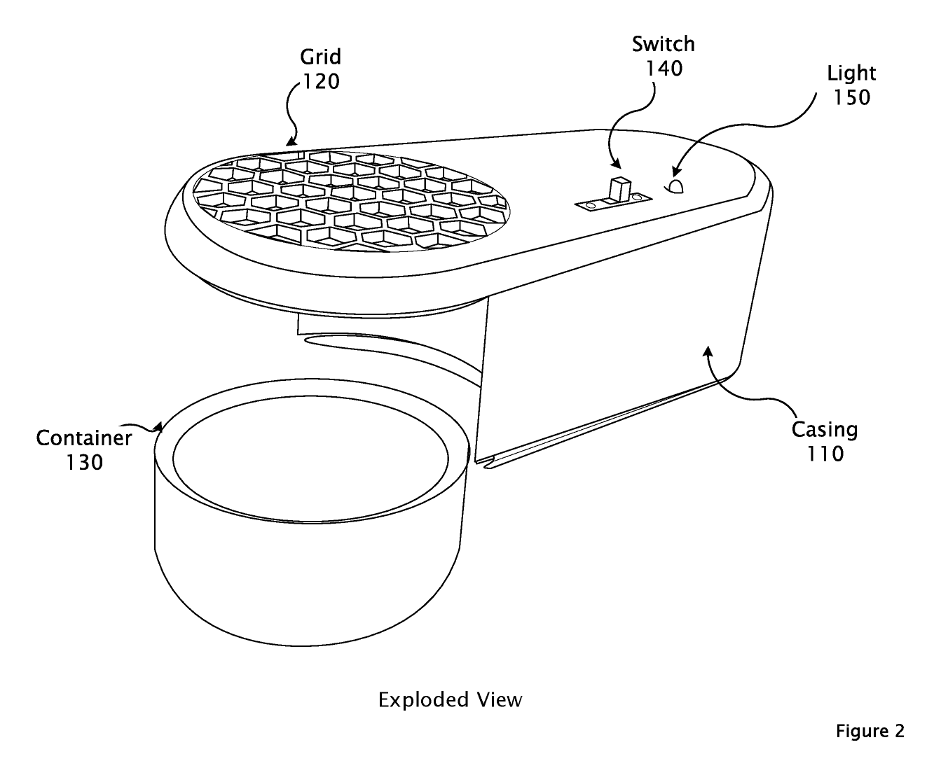

FIG. 2 is an exploded view of Insect Control Device 100, according to one embodiment. Insect Control Device 100 may comprise Casing 110, which may enclose electronics. Casing 110 may include an energized shock Grid 120. Grid 120 may comprise a tightly-spaced mesh with sufficient energy to electrocute small insects and prevent breeding, for example, by killing insects before they lay eggs that come into contact with Grid 120.

In one embodiment, Grid 120 may have outer layers made of an electrical insulator material that is highly resistant to a flow of electrical current, for example, to safeguard users from electrically energized wires or parts. For example, a top and bottom layer of Grid 120 may be made of polyvinyl chloride (PVC), Acrylonitrile butadiene styrene (ABS) or other plastic, rubber, or other material. In one embodiment, a top and bottom layer of Grid 120 may be made the same material of Casing 110.

A detachable Container 130 may be disposed beneath Grid 120. Container 130 may hold bait and catch insect carcasses. Container 130 may be baited with a solution that is non-toxic to humans, such as vinegar, wine, fruit, or soapy water, for example. Container 130 may also contain biological and decaying matter, for example. In one embodiment, Container 130 may have rounded internal angles, for example, to facilitate easy wiping or cleaning. Container 130 may be made of a waterproof material that is dishwasher safe or stain resistant, for example. In another embodiment, Container 130 may be made of an acid-resistant material, for example, to prevent corrosion from acidic baits such as vinegar.

On and off Switch 140 may be disposed on Casing 110. In one embodiment, Switch 140 may control a timer or other device settings, for example, Bluetooth, Wi-Fi, or wireless connection. Light 150 may be disposed on Casing 110 and may indicate that the device is on, motion has been detected, or other settings.

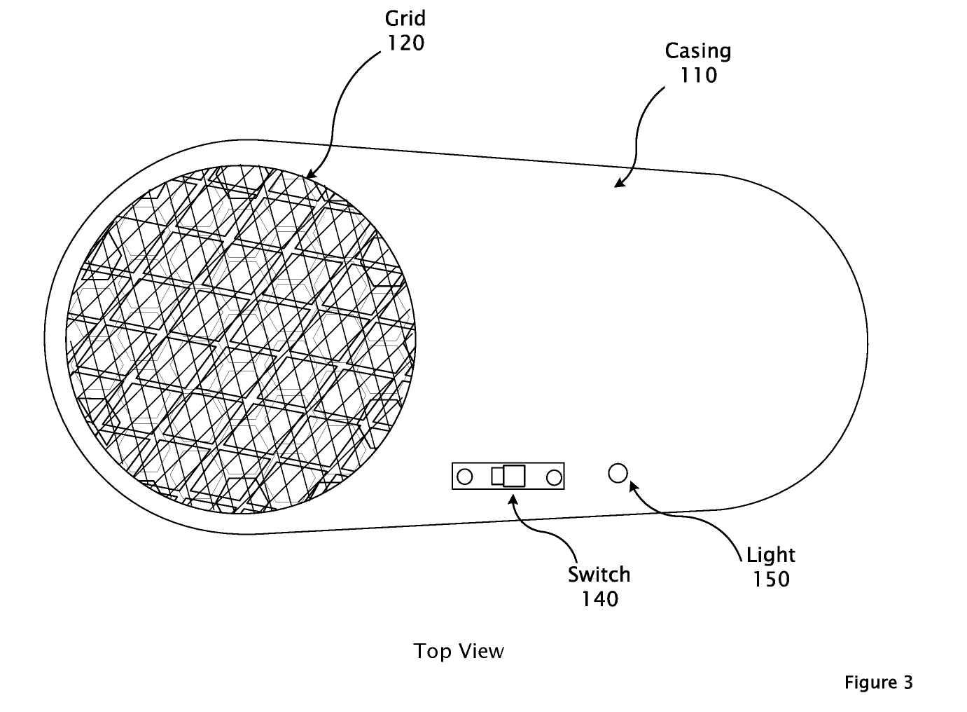

FIG. 3 is a top view of Insect Control Device 100, according to one embodiment. Because Insect Control Device 100 may be operable to kill small insects, it may require lower voltage requirements than conventional insect control devices. Insect Control Device 100 may provide a longer battery life and enhanced safety to users. For example, an electronic shock would be lower and less harmful to a person if Grid 120 of Insect Control Device 100 were accidentally bridged. An electrical current may be so small as to not represent any physical danger to a person, less so than a regular static shock, for example. Insect Control Device 100 may emit a sound, for example, a cracking sound, when an insect straddles Grid 120. The sound may serve as a safety mechanism to alert people and prevent them from getting shocked, for example.

In one embodiment, Grid 120 may comprise layers of energized fine and tightly-spaced mesh, considerably increasing a chance that an insect, for example, a fruit fly, will get electrocuted when trying to pass through Grid 120. In one embodiment, Grid 120 may not be subject to arcing.

In one embodiment, Grid 120 may have outer layers made of an electrical insulator material that is highly or totally resistant to the flow of electrical currents to safeguard users from electrically energized wires or parts. For example, a top and bottom layer of Grid 120 may be made of polyvinyl chloride (PVC), ABS or other plastic, rubber, or other material. In one embodiment, a top and bottom layer of Grid 120 may be made the same material of Casing 110.

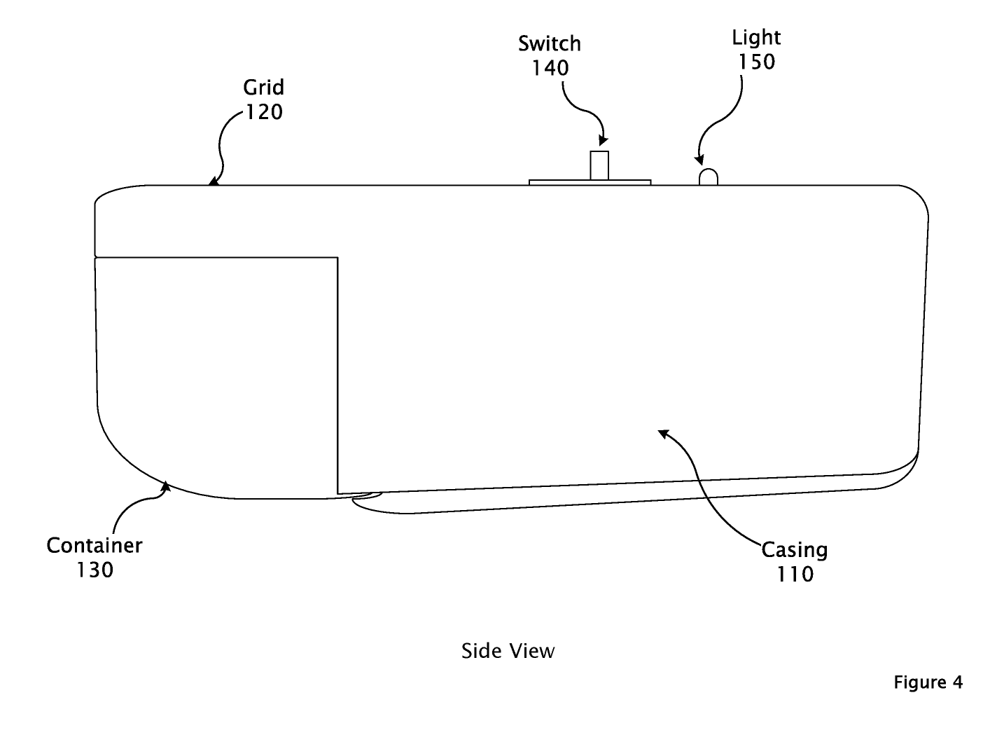

FIG. 4 is a side view of Insect Control Device 100, according to one embodiment. Insect Control Device 100 may comprise a Casing 110 operable to enclose electronics. Casing 110 may include a tightly-spaced shock Grid 120 with sufficient energy to electrocute small insects and prevent breeding.

Container 130 may be disposed beneath Grid 120. Container 130 may hold bait and catch carcasses of insects. On and off Switch 140 may be disposed on Casing 110. In one embodiment, Switch 140 may control a timer or other device settings, for example, Bluetooth, Wi-Fi, Global Positioning System (GPS), near-field communication (NFC) or other wireless connection. Light 150 may be disposed on Casing 110 and may indicate that the device is on, motion has been detected, or other settings.

In another embodiment, Insect Control Device 100 may be operable to hang instead of sitting flat on a surface. In yet another embodiment, a cover having a shape of a frustum, or cone with its top removed, for example, may be disposed over Grid 120 to prevent an electrical shock from propelling insect carcasses onto surfaces, such as food preparation areas. In one embodiment, insects may crawl into a frustum or cone cover before encountering Grid 120, and the cover may contain an insect's body parts upon electrocution and propulsion, for example.

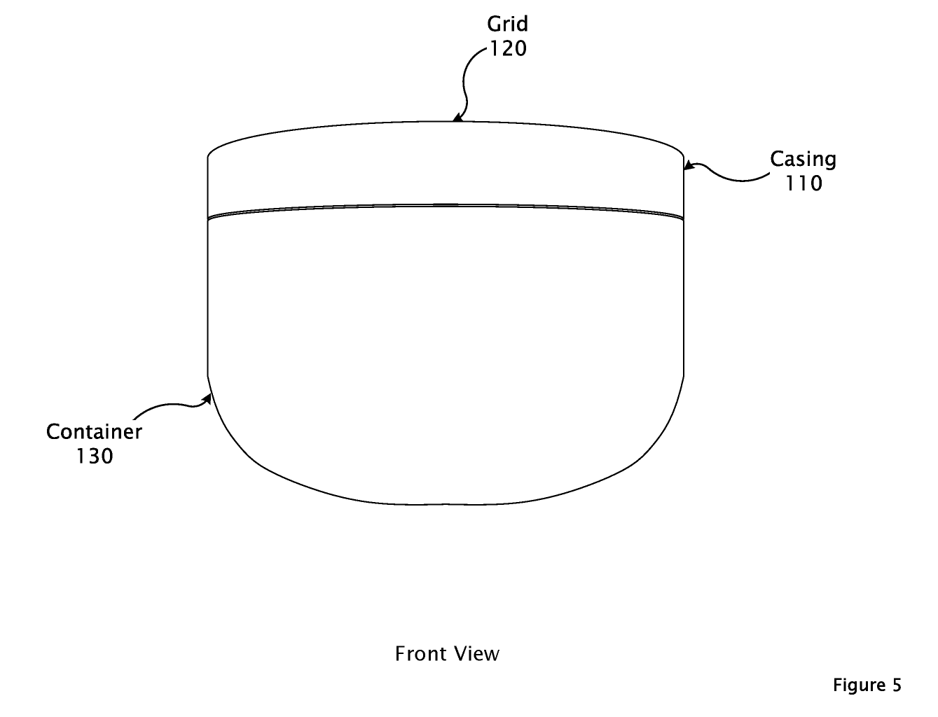

FIG. 5 is a front view of Insect Control Device 100, according to one embodiment. Insect Control Device 100 may be a baited trap comprising Casing 110, which may enclose electronics. Insect Control Device 100 may include a fine and tightly-spaced shock Grid 120 with sufficient energy to electrocute small insects and prevent breeding.

A detachable Container 130 may be disposed beneath Grid 120. Container 130 may hold bait and catch insect carcasses. On and off Switch 140 may be disposed on Casing 110. In one embodiment, Switch 140 may control a timer or other device settings, for example, Bluetooth, Wi-Fi, Global Positioning System (GPS), near-field communication (NFC) or other wireless connection. Light 150 may be disposed on Casing 110 and may indicate that the device is on, motion has been detected, or other settings.

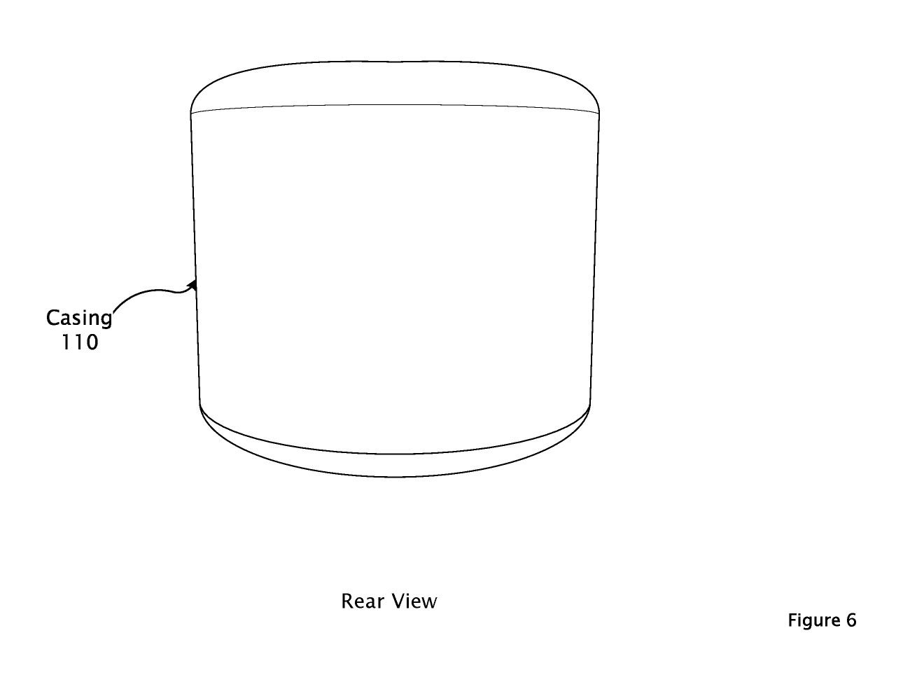

FIG. 6 is a rear view of Insect Control Device 100, according to one embodiment. Insect Control Device 100 may be a baited trap comprising Casing 110, which may enclose electronics. In one embodiment, a user may clean Insect Control Device 100 by wiping down Casing 110 with a damp cloth with the device turned off or batteries removed, for example. Grid 120 may be cleaned of insect remains with a brush, for example. In another embodiment, Casing 110 may be detachable from the electronics of Casing 110 or Grid 120, and Insect Control Device 100 may be suitable for submersion in water or dishwasher cleaning.

In one embodiment, Insect Control Device 100 may be configured for mass production. For example, draft angles may be added to make Insect Control Device 100 suitable for injection molding.

A person skilled in the art will understand that Insect Control Device 100 and its components may comprise various shapes, colors, and sizes. In one embodiment, it may have properties attractive to small flying insects, for example, an alluring scent, sound, or color such as red or orange, a light in or behind the grid such as an ultraviolet (UV) light-emitting diode (LED), or shapes or textures that mimic food or nature, for example. Insect Control Device 100 or its components may be made of a combination of material, for example, polymers such as PVC or ABS plastic, composites such as carbon fiber or fiberglass, rubber, wood, or metal. In another embodiment, Insect Control Device 100 may be made of an acid-resistant material, for example, to prevent corrosion to a container holding an acidic bait such as vinegar. In yet another embodiment, Insect Control Device 100 may be made of a waterproof or glow-in-the-dark material.

In one embodiment, electronics of Casing 110 may not be user-serviceable, except for battery replacement, for example. In yet another embodiment, Insect Control Device 100 may use AC stepped down to three volts DC to allow better continuous or dual operation with rechargeable batteries, for example, to allow placement of Insect Control Device 100 in any location. In another embodiment, Insect Control Device 100 may provide multiple days of continuous use, for example, four days, before batteries require replacement.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. An insect control device, comprising:
a casing, the casing operable to house electronics;
a grid, the grid coupled to the casing, wherein the grid is operable to emit sufficient energy to electrocute an insect; and
a container, the container disposed beneath the grid.

2. The grid of claim 1, further comprising a tightly-spaced mesh.

3. The grid of claim 1, further comprising a plurality of layers.

4. The grid of claim 1, wherein a top and bottom layer are made of an electrically insulating material.

5. The grid of claim 1, comprising a light operable to attract insects, the light from the list containing ultraviolet (UV) light-emitting diode (LED).

6. The container of claim 1, wherein the container is detachable.

7. The container of claim 1, wherein the container is made of an acid-resistant material.

8. The insect control device of claim 1, further made of a waterproof material.

9. The insect control device of claim 1, wherein insect control device or its components are of a material selected from the list containing polyvinyl chloride (PVC) or acrylonitrile butadiene styrene (ABS) plastic, carbon fiber, fiberglass, metal, rubber, and wood.

10. The insect control device of claim 1, further comprising a color attractive to an insect.

11. The insect control device of claim 1, further comprising a sound attractive to an insect.

12. The insect control device of claim 1, further comprising a shape or texture of a biological or decaying matter.

13. The insect control device of claim 1, further emitting a scent attractive to an insect.

14. The insect control device of claim 1, further made of a glow-in-the-dark material.

15. The casing of claim 1, further comprising a switch.

16. The casing of claim 3, further comprising a light.
